(19) United States
(12) Patent Application Publication
(10) Pub. No.: US 2007/0085248 A1
(43) Pub. Date: Apr. 19, 2007

(54) Shock absorbing member

(76) Inventor: Cheng-Chung Chang, Hsi-Chi City (TW)

Correspondence Address: LIN & ASSOCIATES INTELLECTUAL PROPERTY, P.O. BOX 2339, SARATOGA, CA, 95070-0339, US

(21) Appl. No.: 11/250,810

(22) Filed: Oct. 14, 2005

(51) Int. Cl. F16M 1/00

(52) U.S. Cl. 267/136; 248/638

(57) ABSTRACT

A shock absorbing member made by soft material includes a shank with a head and a spherical member connected to a first end and a second end of the shank. A plurality of shock absorbing plates extend radially outward from the shank and located at two positions along the shank. A source of vibration such as a fan is clamped between the two groups of shock absorbing plates.

### BACKGROUND OF THE INVENTION

1. Field of the Invention

The present invention relates generally to a shock absorbing member which includes several shock absorbing plates and is in contact with the source of vibration.

2. The Prior Arts

A computer CPU generates a lot of heat which has to be removed from the CPU so as to maintain the normal function of the CPU. In order to quickly remove the heat from the CPU, the computer case has a plurality of ventilation holes and a fan is connected to the CPU so as to blow the heat away from the CPU and the heat escapes via the ventilation holes. However, the fan includes a rotational shaft on which blades are connected and the rotation of the shaft vibrates and the vibration generates noise which is the main source of noise of the computer. The vibration could be harmful to the computer. The fan generally is fixed by screws which require a screw driver to position the fan. The screws can be loosened by the vibration and once the screws are loosened, the vibration becomes severe.

### SUMMARY OF THE INVENTION

A primary objective of the present invention is to provide a shock absorbing member which can be used as a nail to position the fan and includes shock absorbing plates on the shank of the shock absorbing member so that the vibration can be absorbed by the shock absorbing member.

A second objective of the present invention is to provide a shock absorbing member which is made by soft material and in a form of a nail which can be used to position an object.

The present invention includes a shank with a head on a first end thereof and a spherical member on the other end. A plurality of shock absorbing plates extend radially outward from the shank and object can be clamped between shock absorbing plates of two shock absorbing members.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a cross-sectional view of the shock absorbing member of the present invention;

FIG. 2 is perspective view of the shock absorbing member of the present invention;

FIG. 3 is a cross-sectional view to show that a fan is positioned between two shock absorbing members;

FIG. 4 is a cross-sectional view to show another way to position the fan between two shock absorbing members, and

FIG. 5 is a cross-sectional view to show that the fan is positioned between two another embodiment of the shock absorbing members.

### DETAILED DESCRIPTION OF THE PREFERRED EMBODIMENT

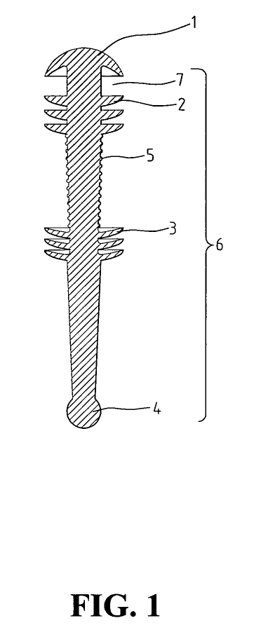

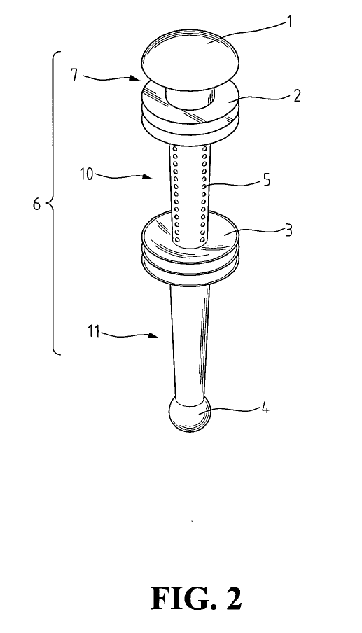

With reference to the drawings and in particular to FIGS. 1 and 2, the shock absorbing member of the present invention is made by soft material such as rubber and comprises a shank 6 and a head 1 is connected to a first end of the shank 6 and a spherical member 4 is connected to a second end of the shank 6. The head 1 is a semi-spherical member. A plurality of shock absorbing plates extend radially outward from the shank 6.

The shock absorbing plates are located at two positions along the shank 6 and include a first group 2 and a second group 3, a distance is defined between the first and second groups 2 and 3. A plurality of bosses 5 protrude from the shank 6 between the first group 2 and the second group 3. The shank 6 is a tapered tubular member and a diameter is gradually reduced from the first end toward the second end of the shank 6. The first embodiment of the shock absorbing member of the present invention includes an upper section 7, a mediate section 10 and a lower section 11.

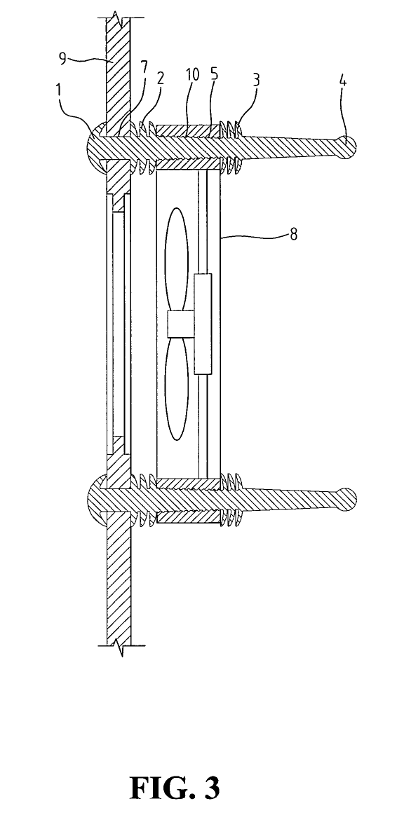

As shown in FIG. 3, the shock absorbing members extend through the computer case 9 and the fan 8. The computer case 9 is positioned in the upper section 7 and the fan 8 is position in the mediate section 10 between the first group and the second group 3 of the shock absorbing plates. A gap is defined between the adjacent shock absorbing plates of each of the first group 2 and the second group 3 of the shock absorbing plates so that the shock due to vibration of the fan 8 can be absorbed by deformation of the shock absorbing plates. The bosses 5 on the shank 6 enhance the connection between the fan 8 and the shank

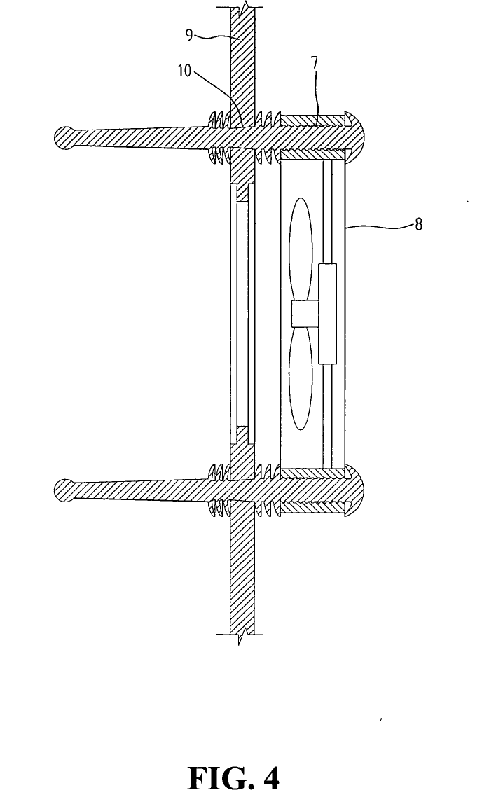

As shown in FIG. 4 which shows another arrangement to position the fan 8 and the computer case 9. The computer case 9 is positioned in the mediate section 10 between the first group and the second group 3 of the shock absorbing plates, and the fan 8 is positioned in the upper section 7.

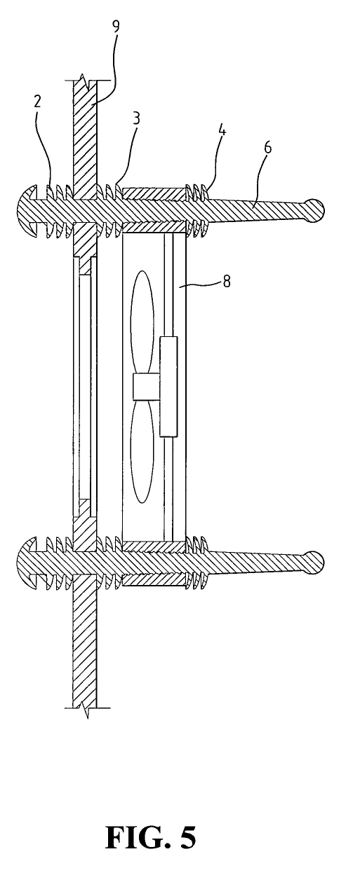

As shown in FIG. 5 which shows a second embodiment of the shock absorbing member wherein there are three group of shock absorbing plates on the shank 6, that is the first group 2, the second group 3 and the third group 4 of the shock absorbing plates. The computer case 9 is positioned between the first and second groups 2, 3, and the fan 8 is positioned between the second and third groups of the shock absorbing plates.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A shock absorbing member comprising
a shank and a head connected to a first end of the shank;
a plurality of shock absorbing plates extend radially outward from the shank.

2. The shock absorbing member as claimed in claim 1, wherein a spherical member is connected to a second end of the shank.

3. The shock absorbing member as claimed in claim 1, wherein the shank is a tapered tubular member and a diameter is gradually reduced from the first end toward the second end of the shank.

4. The shock absorbing member as claimed in claim 1, wherein the head, the shank and the shock absorbing plates are made by soft material.

5. The shock absorbing member as claimed in claim 1, wherein the shock absorbing plates are located at two positions along the shank.

6. The shock absorbing member as claimed in claim 1, wherein a distance is defined between the head and the shock absorbing plates located close to the head.

7. The shock absorbing member as claimed in claim 5, wherein a plurality of bosses protrude from the shank and located between the two positions of the shock absorbing plates.
